(19) United States
(12) Patent Application Publication
(10) Pub. No.: US 2005/0192973 A1
(43) Pub. Date: Sep. 1, 2005

(54) Visual database management system and method

(75) Inventors: David P. Sperling, Laguna Niguel, CA (US); Murtaza A. Ghulamali, Mission Viejo, CA (US); George J. Dabrowski, Aliso Viejo, CA (US)

Correspondence Address: CROWELL & MORING LLP;INTELLECTUAL PROPERTY GROUP, P.O. BOX 14300, WASHINGTON, DC, 20044-4300, US

(73) Assignee: Smith Micro Software, Inc.

(21) Appl. No.: 10/777,867

(22) Filed: Feb. 12, 2004

(51) Int. Cl. G06F 7/00

(52) U.S. Cl. 707/100

(57) ABSTRACT

A system for reconciling data in a plurality of databases includes a user interface adapted to provide a graphical representation of at least a subset of the records from each of the plurality of databases and to allow for interactive manipulation of the database records through the graphical representation. The plurality of databases are stored on a portable device, or a personal computer. In some embodiments, at least two of the databases have different record structures. The graphical representation includes a visually distinctive graphical scheme for each of the plurality of databases, as well as a visually distinctive graphical scheme for each unique combination of the plurality of databases. Each record found in a single database is displayed using the single database's corresponding graphical scheme and each record found in more than one database is displayed using the graphical scheme corresponding to the combination of databases.

### BACKGROUND OF THE INVENTION

The present invention relates generally to the management of data that is shared across multiple devices and/or databases.

Electronic databases are a part of everyday life, storing information such as calendars, contacts lists, and task lists. Many users maintain more than one copy of these databases in various computers and devices. For example, separate calendar databases may be stored on computers at work and at home, as well as on handheld devices such as personal digital assistants (PDAs), mobile phones and notebook computers.

Managing data across a plurality of devices can be burdensome and frustrating for users. The devices often have different sets of capabilities and limitations, and are commonly used for different purposes. Many mobile phones, for example, support calendaring programs, but have a limited storage capacity and awkward user interfaces that make it inconvenient for users to enter large amounts of data. PDAs are typically designed for use with a computer based calendar and often provide more robust calendar features than mobile phones. Yet even with PDAs, users typically enter their calendar events on a personal computer and then transfer the events to the mobile device so they will be notified of their schedules when away from their personal computers.

Personal computers have more processing power, memory, storage and display capabilities than mobile devices. The database entries on a computer can be more detailed, showing more information in a single view, and may include large attachments such as graphics files. Most mobile devices simply cannot store all of this information. For example, even when used in conjunction with a personal computer, mobile phone calendar databases are typically only used as a reminder of important events, and are limited to displaying a subset of the total calendar content.

Synchronization applications are available to automatically synchronize entries stored in the databases on each device. When a conflict is found (e.g., when corresponding records on two devices differ) the user may be asked how to best resolve the conflict. The user is often asked to make these decisions on-the-fly and may end up selecting an undesirable resolution to the conflict and losing important data. The user may also configure the synchronization software to automatically resolve the conflict, e.g., select the entry having the most recent date. When a change is made automatically, the user may never know whether a conflict arose, how it was resolved and whether the change would interfere with other entries. For example, a calendar entry may be scheduled or changed by a user's secretary or another person in an office workgroup and the user may not know of the new (or changed) entry because the conflict is resolved without the user's intervention.

Synchronization products are commonly used to synchronize two databases. For example, a person may synchronize a computer at work may with a mobile phone. These products make it easy to indiscriminately dump all data from one device to another and will automatically resolve conflicts that may arise. The user, however, may wish to download only a select portion of the database entries to the mobile phone, while maintaining a more detailed calendar on the work computer. Further, the limited user interfaces on many mobile devices make it difficult to view and edit the contents of the database, which is another reason why so many users maintain their data on a computer. In most practical uses, the mobile device is often limited to maintaining a copy of the data already on a computer. But, users may want to separate some information, such as a work calendar and a personal calendar. The user may only want a select few entries from a work calendar to appear on a personal mobile phone, and vice versa. The user may also wish to consolidate certain entries from various sources such as a personal calendar, a work calendar and a family calendar to maintain important events on the phone. Prior art systems do not provide a practical solution to setting up a mobile phone and managing the information in a mobile phone in this manner.

Device manufacturers often take short cuts to maximize the functionality of their device's memory capabilities. For example, some mobile phones include a calendar feature that stores names, dates and whether the record is recurring, but does not store the date in which the record was last modified. When there is a conflict, the synchronization program may not know which entry is correct one to keep. A history file (e.g., a third database stored on the computer with additional information about the data in the two databases) may be used to assist in the process, but such files may not reflect changes if the phone has entries from multiple computers. Alternatively, the user may be prompted through a pop up window to resolve the conflict manually, but these windows often fail to provide the user with the context necessary to resolve the conflict.

Many users find synchronization products difficult to use because they do not fully understand how database synchronization really works and why they don't always get what they expect. A user may take the time to configure the synchronization program before it is used, but after that how or whether the synchronization program is handling certain data becomes a mystery. In practical applications, the mobile device is thus often limited to holding a copy of data from a single computer. The user may lose data and not know why or how to resolve the situation. In making the synchronization easy, the power and flexibility of using multiple devices is lost in the complexity.

In view of the deficiencies in the prior art, there is a need for an easy to use database management system that allows a user to manage the information across a plurality of devices.

### SUMMARY OF THE INVENTION

The present invention provides a visual database management system that allows a user to easily manage data from a plurality of databases.

In one embodiment, a system for reconciling data in a plurality of databases includes a user interface adapted to provide a graphical representation of at least a subset of the records from each of the plurality of databases and to allow for modification of the database records through the manipulation of the graphical representation. The plurality of databases may be stored on a portable device, a personal computer or other device. In some embodiments, the two databases have different record structures, and there is some translation between them.

The graphical representation may include a visually distinctive graphical scheme for each of the plurality of databases, as well as a visually distinctive graphical scheme for each unique combination of the databases. Each record found in a single database is displayed using the single database's corresponding graphical scheme and each record found in more than one database is displayed using the graphical scheme corresponding to the respective combination of databases.

A communications link is provided to each of the plurality of databases, and the user interface is adapted to retrieve records from each of the plurality of databases through its corresponding communications link. In various embodiments, at least one communications link includes an application programming interface (API), a wireless link or the Internet.

The interactive manipulations include copying a record from a first database to a second database and deleting a record from at least one database, and may even include moving a record. In an alternative embodiment, the system may include a history database identifying records found in more than one of the plurality of databases.

In a method of operation, a method for managing a plurality of calendar databases includes defining a plurality of visually distinctive graphical schemes, each graphical scheme corresponding to one or more of the devices; retrieving from each device a set of records from the corresponding calendar database, the set of records falling within a date range; and graphically displaying each of the retrieved records according to its corresponding graphical scheme. In one embodiment, the number of graphical schemes used in displaying the records is greater than the number of databases.

In another embodiment, the number of devices is two and three distinctive graphical schemes are defined. The first graphical scheme corresponds to records retrieved only from the first device. The second graphical scheme corresponds to records retrieved only from the second device. The third scheme corresponds to records retrieved from both the first and second devices.

A user interface is provided for visually manipulating the graphically displayed records, and database operations are performed in response to the visual manipulations. The user interface may be adapted for interactively synchronizing the plurality of databases. In another embodiment, a record retrieved from the first device corresponds to a record retrieved from the second device when a subset of fields from the first record matches a subset of fields from the second record. Corresponding records are displayed as a single graphical representation. In an alternative embodiment, each graphical scheme includes a visually distinctive color.

In another method, a first calendar database stored on a computer and second calendar database stored on portable device are reconciled. A subset of records from each database, across a selected date range, is displayed. Where a record from the first database corresponds to a record from the second database, the two records are displayed as a single record. At least one of the first and second databases is modified in response to user manipulation of the displayed records. In alternative embodiments, the date range is selected by a user, and the modification may include copying records between databases, deleting records, or synchronizing the records of the two databases.

In another embodiment, a computer-readable medium stores executable instructions for use in managing a plurality of calendar databases. The program includes an interface to each of the plurality of databases which is adapted to obtain a subset of records from each of the plurality of databases, the subset of records spanning a date range. A user interface is adapted to display a graphical representation of the obtained records, allow for interactive manipulation of the displayed graphical representations, and perform at least one database operation on at least one of the plurality of databases in response to the interactive manipulations.

A more complete understanding of the present invention will be afforded to those skilled in the art, as well as a realization of additional advantages and objects thereof, by a consideration of the following detailed description. Reference will be made to the appended sheets of drawings, which will first be described briefly.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 illustrates an embodiment of a visual database management system in accordance with the present invention;

FIG. 2 is flow chart illustrating an operation of the embodiment of FIG. 1;

FIGS. 3a and 3b are flow charts illustrating a method for displaying records;

FIG. 4 illustrates a correspondence table in accordance with the embodiment of FIG. 1;

FIG. 5 illustrates a user interface in accordance with the an embodiment of the present invention;

FIG. 6 illustrates the user interface of FIG. 5 with a pop-up menu in accordance with an embodiment of the present invention;

FIG. 7 illustrates the user interface of FIG. 5 with a pop-up record editing screen in accordance with an embodiment of the present invention;

FIG. 8 illustrates the user interface of FIG. 5 with a pop-up editing screen in accordance with an embodiment of the present invention; and

FIG. 9 illustrates an alternate user interface in accordance with an embodiment of the present invention.

### DETAILED DESCRIPTION OF THE DRAWINGS

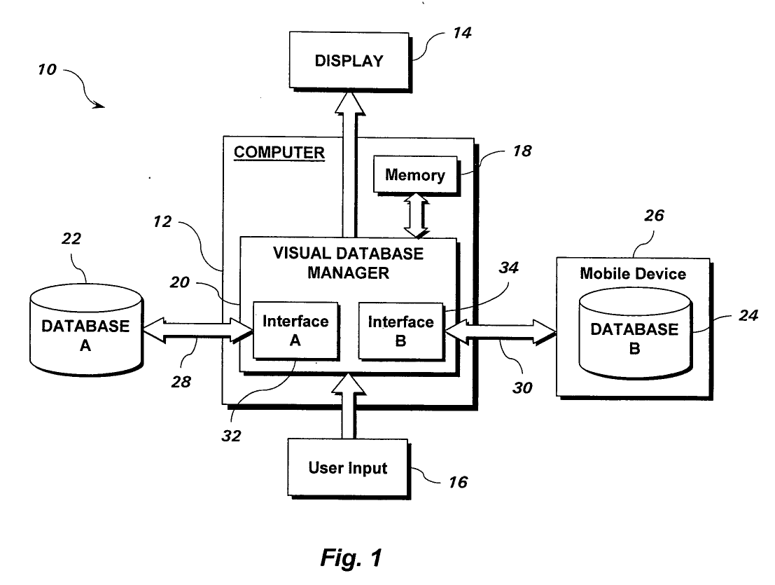

An embodiment of the present invention will now be described with reference to FIG. 1. A visual database management system 10 preferably includes a general purpose computer 12, such as a personal computer or laptop computer, having a display 14, one or more input/output devices 16, such as a keyboard and mouse, a memory 18 and a visual database manager software application 20. The display may be a color computer monitor, but in alternative embodiments may be any device that is capable of visually representing graphical information.

The computer 12 is adapted to access at least two databases 22 and 24. In a embodiment, database 22 is a Microsoft Outlook calendar database that is stored on, or connected to, the computer 12. The database 24 is preferably a calendar database that is stored on a mobile device 26, such as a mobile phone or PDA. In alternate embodiments, the databases may be located on any device, in any location, that is capable of establishing a communications link with the computer 12, including being stored on the computer 12 itself, being stored on a server accessible through a network such as the Internet, and being stored on a wireless device that is accessible through a wireless communications link. It will be appreciated that although calendar databases are described herein, the databases may represent other types of data in accordance with the present invention, such as a contacts database, an email database, and a notes database.

In operation, the visual database management system 10 provides users with the ability to move data records between their PC calendars 22 and the calendars 24 in their wireless or portable devices. Many portable devices, such as mobile phones and PDAs, have limited calendar capabilities as compared to the PC calendars. This may be as a result of a variety of factors such as a proprietary application program resident on the mobile device 26, user configurations or hardware and memory limitations of the mobile device 26. As a result, the records structures of the two databases 22 and 24 will often differ.

The visual database manager software 20 may include a mapping and configuration utility, along with related data, which is used for translating records between the two databases 22 and 24. The mapping and configuration data may include a description of the record structures of known databases and information for mapping at least one field from the PC database 22 to the mobile database 24. The data may further include information for converting the content between databases. For example, dates may be stored in different formats, or a field from the database 24 may be shorter than the corresponding field in database 22. In an alternate embodiment, the mapping and configuration utility may also allow the user to define the mapping between fields and the manner of translating the content.

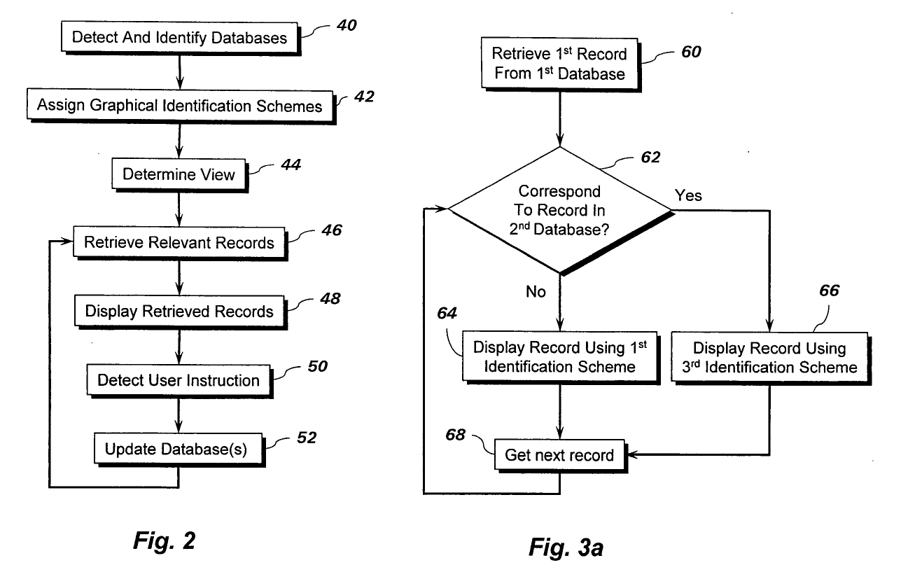

The operation of the visual database management system 10 will now be described with reference to FIGS. 1 and 2. FIG. 2 is a flow diagram illustrating the operation of the visual database manager software 20. In step 40, visual database manager (VDM) 20 searches for available databases. First, the VDM 20 attempts to autodetect personal information managers (PIMs) used on the computer 12 (e.g., Outlook, ACT!, etc.). If the VDM 20 finds more than one, the user is prompted to identify which PIMs the user would like to view. Next, the VDM 20 looks for available mobile devices 26. This may be controlled either manually or automatically. When autodetecting mobile devices, the VDM 20 checks the computers' communication ports for a wireless device. If a device is detected, the VDM 20 can then issue queries to determine the type of wireless device. The VDM 20 could also look for devices attached to the computer 12 via a serial port, USB cable or other hard connection.

A decision tree may be used during the autodetect procedure to identify a detected device. Once a communications link 30 is established between the VDM 20 and the device 26, the VDM 20 sends a query to the device 26 and awaits a response. Through the decision tree, the VDM 20 may find compatible devices that the VDM 20 software has never seen—for example, due to forward compatibility. The commands sent to the device may reveal the manufacturer and model of the device and allow the VDM 20 software to assume the device's capabilities. An example of such a query would be to attempt to use the commands that the VDM 20 needs to use during operation. The VDM 20 could first attempt to read a data record from the device. If this is successful, the VDM 20 could then attempt to write a record to the device. If the device properly responds then the mobile device may be considered sufficiently identified. In an alternate embodiment, the VDM 20 can include a list of known mobile devices to check when a device is detected or the VDM 20 could prompt the user to identify the device.

After detecting the PIM and the mobile device, the identities are saved in a configuration file for later use. Next, in step 42, visually distinctive graphical identification schemes are chosen for each detected database, and each possible combination of databases. Each graphical identification scheme identifies the source of a database record that is displayed on the screen. For example, in an embodiment, a displayed data record could be located in (1) database 22, (2) database 24 or (3) both. The graphical identification schemes may be retrieved from a configuration file. If none are found in the configuration file, then default schemes may be selected or the user may be prompted to select the required schemes. The graphical identification schemes may include any visual feature that would allow two or more records to be easily distinguishable. In an embodiment, each scheme has a different color: red, orange and blue. In an alternate embodiment, each scheme may include various combinations of colors, shapes and other graphical features.

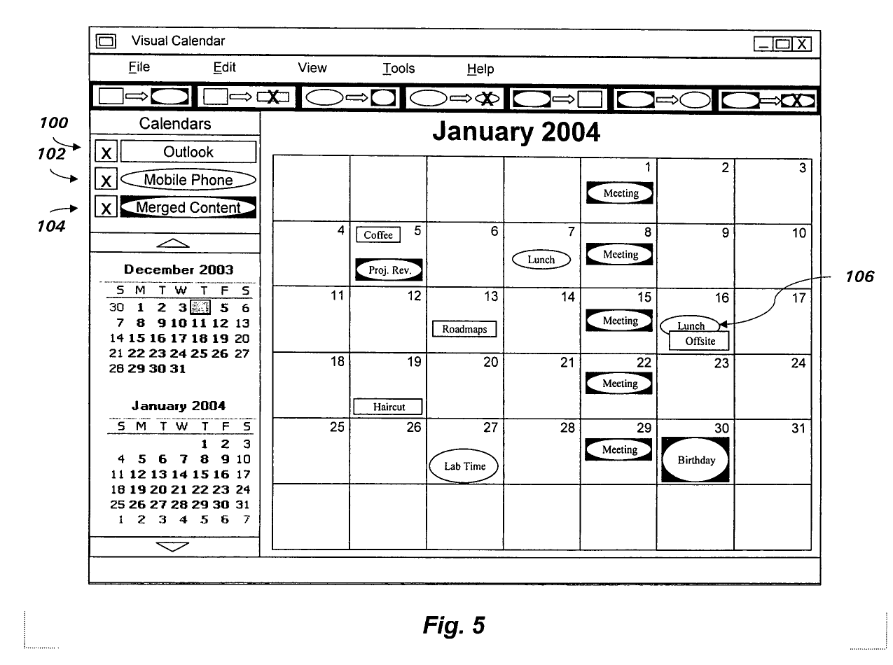

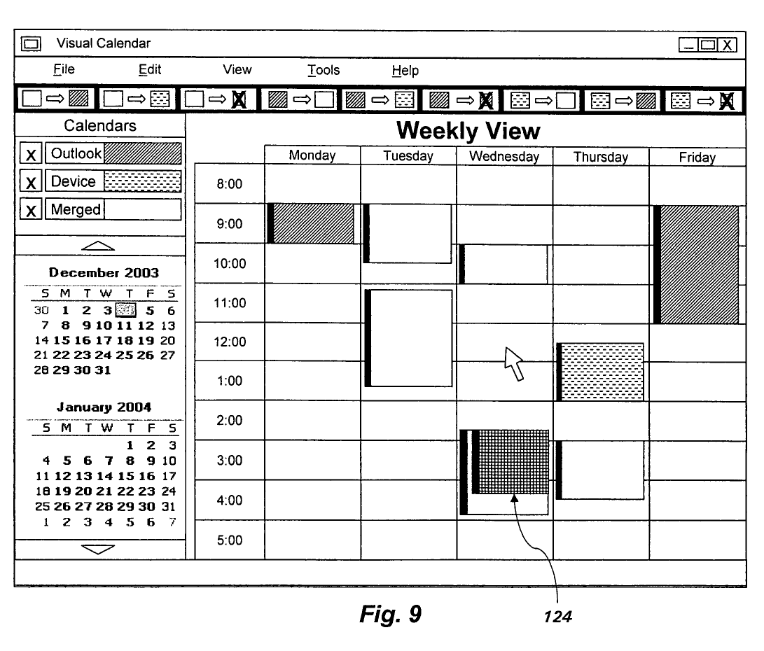

Next, the date range of the records to display on the screen is determined in step 44. This may be determined by default, from a configuration file or by a selected date range. For example, a monthly view is illustrated in FIG. 5 and a weekly view is illustrated in FIG. 9.

In step 46, the records for the selected view are retrieved from the databases 22 and 24 and stored in the memory 18. The visual database manager 20 includes interfaces 32 and 34 through which the VDM 20 communicates with the databases 22 and 24, respectively. The interfaces 32 and 34 may be selected based on the identification of the PIM and mobile device, and provide a link between the VDM 20 and application programming interfaces (APIs) associated with the database that are made available to developers. In an embodiment, data from the PIM and phone are pulled into memory and managed there. Because it is much faster to access database records from the memory 18 than from the device 26, it may be beneficial in some applications to read all of the data from the mobile device 26 into memory as part of the program's startup procedures.

In step 48, the records retrieved from the two databases 22 and 24 are displayed on the screen using the corresponding graphical identification scheme. This is illustrated in FIG. 5, where for purposes of illustration, the view being displayed is the month of January 2004, and the graphical identification schemes are represented by shapes. In another embodiment, each scheme has a distinctive color (not shown). As illustrated, records that are found only in Outlook are displayed on the screen using rectangles 100, records found only on the mobile device are displayed on the screen using ovals 102, and records appearing in both databases are displayed on the screen using ovals inside blackened rectangles 104.

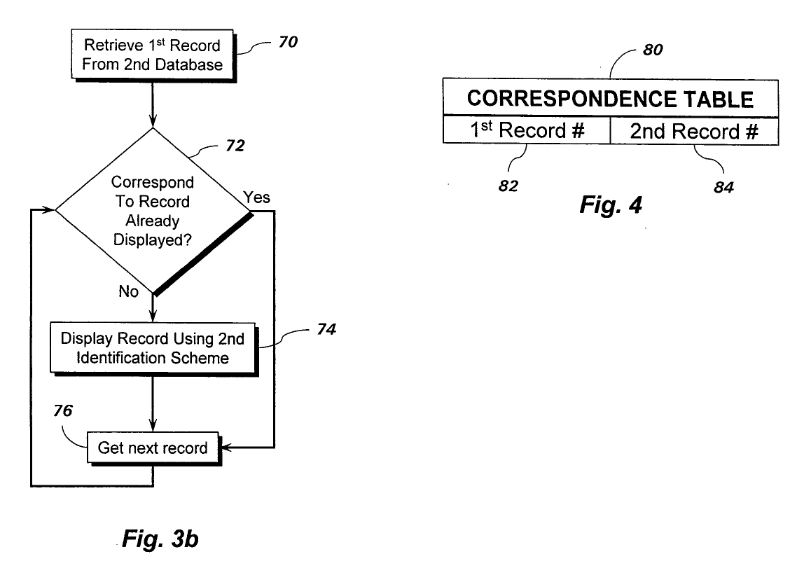

The assignment of an identification scheme to each displayed record will now be described with reference to FIGS. 3a, 3b and 4. Referring to FIG. 3a, in step 60 the first record in one of the databases is selected. A comparison is made in step 62 to determine whether the retrieved record has a corresponding record in the other database. In an embodiment, two records correspond only if the content in all relevant fields are identical—for example, two appointments (i.e., records) having the same starting date, ending date, and description. If one of the records has been changed, the two records will be deemed to not correspond. In an alternative embodiment, a history file (e.g., a third database with additional information about the records stored in the two databases) may be stored on the computer and may be used to track corresponding records in the event that one or more of the records is edited.

A search for a corresponding record may include searching the second database for an identical record or, alternatively, it may include searching a correspondence table 80 which includes a mapping of known corresponding records 82, 84. If a corresponding record is found in step 62 then the record is displayed using the third (i.e., merged content) identification scheme 104 in step 66. If no corresponding records are found, then the record is displayed using the first identification scheme 100. Next, in step 68 the process continues with the next record in the first database.

A correspondence table differs from a history file. A history file is typically stored on the computer and maintains information regarding prior synchronizations between two databases, such as the location of corresponding records in each database, a date on which each record was last edited, or relevant content of each record. When the user exits the VDM 20 software application, the history file is stored for later use. The correspondence table is a temporary table that is typically stored in memory to identify records that are the same and should be displayed as a single record. The correspondence table is often deleted upon program termination.

When all of the records in the first database are displayed, the process outlined in FIG. 3b is performed. In step 70, the first record is retrieved from the second database. A determination is made in step 72 as to whether the record has already been displayed. This may be determined with reference to the correspondence table 80, which should be complete after the initial pass through the first database. Alternatively, a search may be conducted through the first database. If a corresponding record is found, then the record has already been displayed (see step 66 in FIG. 3a) and the process skips ahead to step 76 to select the next record in the second database. If no corresponding records are found, then in step 74 the current record is displayed using the second identification scheme 102.

In step 50 (FIG. 2) the VDM 20 now awaits for user instructions. At this point, the user has a complete view of the data available in the two databases and, referring back to FIG. 5, can visually identify conflicts 106 and change views of the data to see data in one or more of the databases (check boxes at 100, 102, and 104). The user can also readily see the events that appear only on the mobile device 26 or in the PIM database. In the illustrated embodiment, conflicts are shown by overlapping records. In alternative embodiments, conflicts may have their own visually distinct identification scheme or be otherwise visually highlighted.

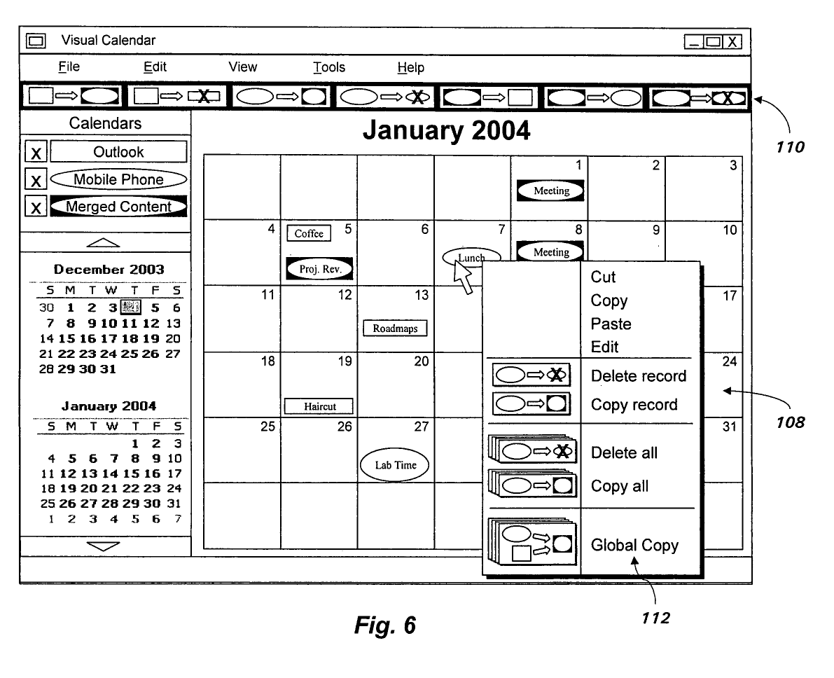

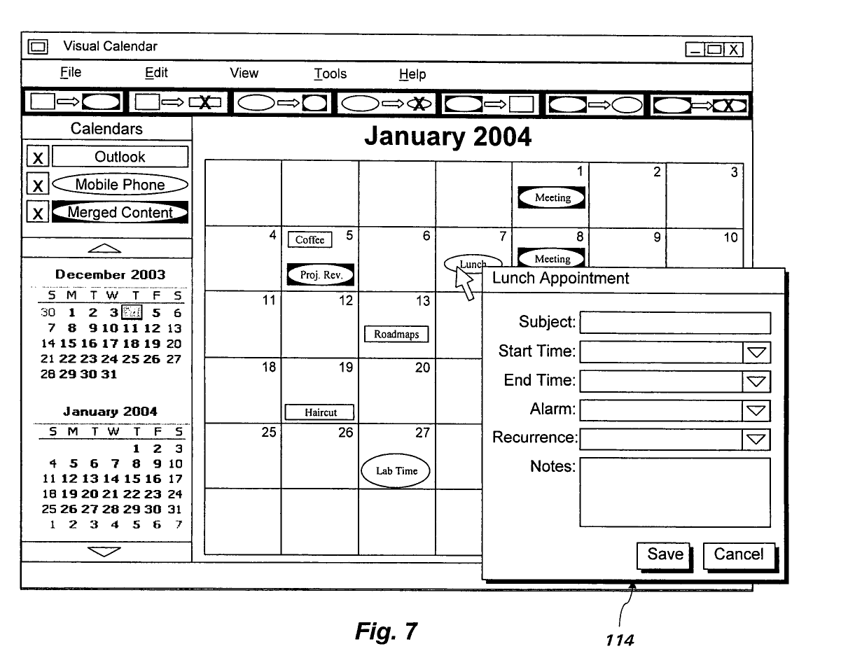

FIG. 6 illustrates operations that can be performed on the displayed records. The user can copy records between databases with the click of a mouse through pop-up menus 108 and toolbars 110, and can also move records if desired. Database synchronization can be simulated using a “global copy” command 112, in which all of the records of a selected database are copied to another database. Referring to FIG. 7, the content of the individual records can be viewed and/or edited in a pop-up window 114 by clicking on the record. In a similar manner, new events can be added to one or both of the databases through the user interface.

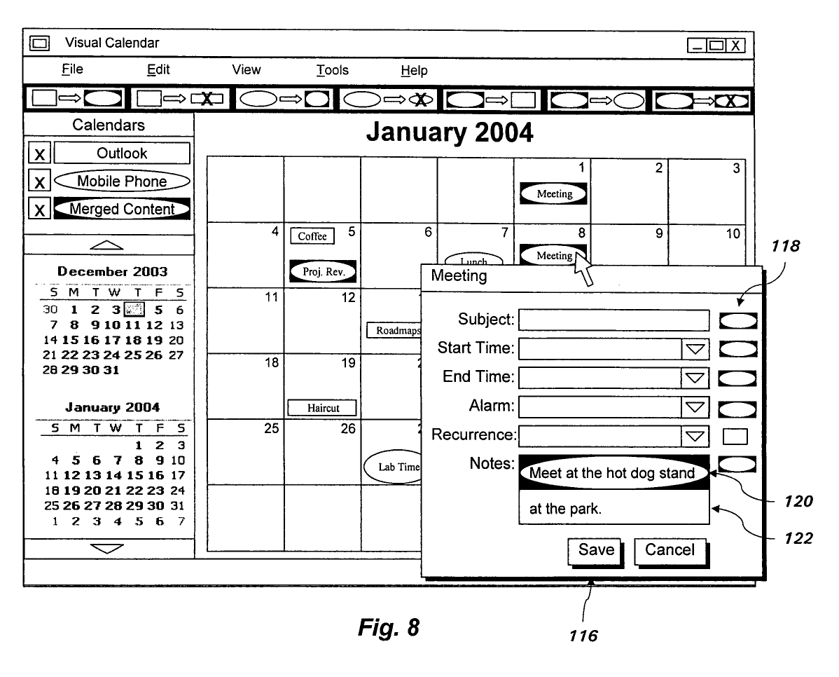

When the record is stored in both databases, the user may have the option of selecting a primary source database which would dictate the record structure available to the user. Alternatively, as illustrated in FIG. 8, the fields from both databases can be displayed in a single window 116 using three graphical schemes 118 (or other identifiers) to identify which fields correspond to which databases and which fields correspond to both databases. For example, if a field found in both databases has a smaller field length in the phone, the first part of the field 120 may have a background graphical scheme indicating that those characters are merged content. The remainder of the field 122 may have the background graphical scheme of the other database. As illustrated, the phrase “Meet at the hot dog stand” will be found in both databases, but the end of the phrase “at the park” will only be found in the Outlook database. In an alternate embodiment, the graphical schemes are colors.

In one embodiment, commands that write to a database (e.g., the global copy command) may check for conflicts between database records and warn the user (e.g., through a pop-up window) that conflicts are present. The user may then resolve the conflicts and continue with the command, skip conflict resolution and run the command with the conflicts or abandon the command. As illustrated in FIG. 5, conflicts may be shown by overlapping events. In an alternate embodiment illustrated in FIG. 9, an additional graphical scheme may be defined for conflicts 124, and overlapping events would be displayed using that scheme to aid the user in visually identifying conflicts. Additional graphical schemes may further be defined to aid the user in resolving the conflict by visually indicating a suggested course of action. Methods for detecting a conflict between records in multiple databases and suggesting a resolution to the conflict are well-known to those skilled in the art of database synchronization.

Referring back to FIG. 2, when the user changes a view, edits a record or otherwise manipulates data, then control moves on to step 52. If a record has been moved, copied, edited or deleted, then the affected databases are updated. In an embodiment, the databases are updated in the background so the operations will have little impact on the functioning of the user interface. Next, in step 46, if the view has changed (e.g., if the user changes the month to be displayed) then relevant records for the new view are retrieved and displayed in step 48.

In an alternative embodiment, the visual representation of changes to the records are shown on the screen, but the databases are not updated until the user hits a “commit” button or the application closes. For example, the write operation to the mobile device may be very slow and the user interface may be undesirably slow if write commands were conducted with every user command. In an alternate embodiment, the database may be updated in the background (e.g., on a different thread) while the user interface remains responsive to the user.

As disclosed in an embodiment, a three color graphical identification scheme is used to show the different records. If an event is moved from Outlook to the mobile device, then the entry changes color on the display to reflect the new source.

Unlike the automatic synchronization programs known in the art, the “visual sync” method provides the user with control over dates and individual records, and gives the user a context in which to make decisions regarding record conflicts. In an alternative embodiment, a command for performing an automatic synchronization on the database is included as part of the user interface, giving the user the choice of both visual sync and automatic sync through the same user interface.

Another advantage of the visual database management system is the ability to manage the databases on a PDA or mobile phone. A benefit of displaying mobile phone data visually on the computer is that the data can be managed while viewing a full-size monitor, using a full-size keyboard and with full calendar capabilities. Due to the small screen size, limited editing and management features and awkward I/O, managing the calendar on the mobile phone is difficult. Through the VDM, the data on the mobile phone is shown visually in an easy to use manner and also allows the user to view a PC database, such as Outlook, in the same view. In addition, the VDM would allow multiple phones and multiple users to update their phone calendar databases on a single PIM calendar. In an alternate embodiment, the VDM can be used as a standalone personal information manager.

The VDM may also be used with a public calendar or other third party calendar available on the Internet or other public source. For example, a user may find a calendar on the Internet listing upcoming sporting events. Through the VDM, this calendar can be displayed along with the users' mobile phone calendar on a single display. The user can immediately see schedule conflicts and the open dates and with a click of the mouse can move one or more of the sporting events to the phone database. In one embodiment, the VDM supports the vCalendar standard. In alternative embodiments, the VDM may be implemented as a web browser or browser plug-in.

Having thus described various embodiments of the present invention, it should be apparent to those skilled in the art that certain advantages of the within described system have been achieved. It should also be appreciated that various modifications, adaptations, and alternative embodiments thereof may be made within the scope and spirit of the present invention.

1. A method of managing a plurality of databases, each database being stored on a separate device, the method comprising:
defining a plurality of visually distinctive graphical schemes, each graphical scheme corresponding to one or more of the devices;
retrieving from each device a record from the corresponding database; and
graphically displaying each of the retrieved records in one of the plurality of graphical schemes;
wherein the number of graphical schemes used in displaying the retrieved records is greater than the number of devices.

2. The method of claim 1 wherein the number of devices is two and wherein three distinctive graphical schemes are defined, a first graphical scheme corresponding to records retrieved only from a first device, a second graphical scheme corresponding to records retrieved only from a second device, and a third graphical scheme corresponding to records retrieved from both the first and second device.

3. The method of claim 1 further comprising:
providing a user interface for visually manipulating the graphically displayed records; and
performing a database operation on at least one of the plurality of databases in response to said visual manipulations.

4. The method of claim 3 wherein the user interface is adapted for interactively synchronizing the plurality of databases.

5. The method of claim 1 wherein each record includes a plurality of fields,
wherein a record retrieved from the first device, corresponds to a record retrieved from the second device when a subset of fields from the first record matches a subset of fields from the second record; and
wherein corresponding records are displayed as a single graphical representation.

6. The method of claim 1 wherein each graphical scheme includes a visually distinctive color.

7. The method of claim 1 further comprising:
generating a third database having a record for each corresponding pair of records; and
displaying the contents of the third database using the third graphical scheme.

8. A system for reconciling data in a plurality of databases, comprising:
a user interface adapted to provide a unique graphical representation of a record from each of the plurality of databases and to allow for interactive manipulation of the database records through the graphical representation.

9. The system of claim 8 wherein the graphical representation includes a visually distinctive graphical scheme for each of the plurality of databases, and a visually distinctive graphical scheme for each unique combination of the plurality of databases;
wherein a record found in a single database is displayed using the single database's corresponding graphical scheme; and
wherein a matching pair of records found in more than one database is displayed as a single record using the graphical scheme corresponding to the combination of databases.

10. The system of claim 8 further comprising a communications link to each of the plurality of databases and wherein the user interface is adapted to retrieve a record from each of the plurality of databases through its corresponding communications link.

11. The system of claim 8 wherein the interactive manipulations include copying a record from a first database to a second database.

12. The system of claim 8 wherein the interactive manipulations further include deleting a record from at least one database.

13. The system of claim 8 further comprising a temporary database table identifying a record found in more than one of the plurality of databases.

14. The system of claim 8 wherein at least one of the plurality of databases is stored on a portable device.

15. The system of claim 8 wherein at least two of the databases have different record structures.

16. The system of claim 8 wherein at least one of the plurality of databases is stored on a personal computer.

17. The system of claim 10 wherein at least one communications link includes an API.

18. The system of claim 10 wherein at least one communications link includes a wireless link.

19. The system of claim 10 wherein at least one communications link includes the Internet.

20. The system of claim 10 wherein at least one communications link includes a serial connection and device specific APIs.

21. A method of reconciling a first database stored on a computer and a second database stored on portable device, the method comprising:
displaying, a record from each database, wherein if a record from the first database corresponds to a record from the second database, the two records are displayed as a single record.

22. The method of claim 21 further comprising modifying at least one of the first and second databases in response to user manipulation of the displayed records.

23. The method of claim 21 wherein each database is a calendar database and wherein each displayed record falls within a displayed date range.

24. The method of claim 22 wherein the step of modifying includes copying the records selected by a user from the first database to the second database.

25. The method of claim 22 wherein the step of modifying includes deleting one or more records selected by a user from at least one of the first and second databases.

26. The method of claim 22 wherein the step of modifying includes synchronizing the first and second databases.

27. A computer-readable medium storing executable instructions for use in managing a plurality of calendar databases, the program comprising:
an interface to each of the plurality of databases adapted to obtain a subset of records from each of the plurality of databases, the subset of records spanning a date range; and
a user interface adapted to display a graphical representation of the obtained records, allow for interactive manipulation of the displayed graphical representations, and perform at least one database operation on at least one of the plurality of databases in response to the interactive manipulations.

28. The computer-readable medium of claim 27 wherein the user interface is adapted for synchronizing the plurality of calendar databases.

29. The computer-readable medium of claim 28 wherein the databases are reconciled without using an intermediate file.

30. A method comprising:
defining a plurality of graphical schemes;
selecting a record from a first database;
comparing the selected record to a record from a second database; and
assigning one the plurality of graphical schemes to the selected record based on the comparison.

31. The method of claim 30 further comprising graphically displaying each of the selected records in accordance with the assigned graphical scheme.

32. The method of claim 31 wherein the number of graphical schemes used in displaying the retrieved records is greater than the number of devices.

33. The method of claim 30 wherein the number of databases is two and wherein three distinctive graphical schemes are defined, a first graphical scheme corresponding to records retrieved only from the first database, a second graphical scheme corresponding to records retrieved only from a second database, and a third graphical scheme corresponding to records retrieved from both the first and second database.
